(19) United States
(12) Patent Application Publication
(10) Pub. No.: US 2001/0045048 A1
(43) Pub. Date: Nov. 29, 2001

(54) Articulated fishing lure

(76) Inventor: Rodney Levelle Johnson, Flint, MI (US)

Correspondence Address: Douglas J. McEvoy, Gifford, Krass, Groh, Sprinkle,, Anderson & Citkowski, P.C., 280 N. Old Woodward Ave., Suite 400, Birmingham, MI, 48009, US

(21) Appl. No.: 09/815,743

(22) Filed: Mar. 23, 2001

Related U.S. Application Data
(60) Provisional application No. 60/194,075, filed on Apr. 3, 2000.

(51) Int. Cl. A01K 85/00

(52) U.S. Cl. 43/42.39

(57) ABSTRACT

A swimming jig for use with a standard attachable bait and providing a measure of erratic and lively behavior to the bait during underwater trolling and/or reeling motion. The swimming jig includes a weighted head having a specified three dimensional shape. An arcuate lip is secured to and extends in a substantially forward direction from said weighted head. The lip is further preferably bendable in some fashion to alter the swimming characteristics of the jig. An eyelet extends from a further location of said weighted head and is engaged by a fishing line. A hook extends from a substantially rearward direction of the weighted head and to which the bait is secured. To further strengthen the jig, a stem may be employed which extends through the interior of the weighted head and interconnects the eyelet with the rearwardly extending hook. The hook may further be secured in articulated fashion to the jig head and, upon attachment of a conventional artificial bait, provides an additional element of erratic motion to the jig.

### CROSS REFERENCE TO CO-PENDING APPLICATIONS

The present application claims priority from and is a continuation-in-part of provisional application U.S. Serial No. 60/194,075, filed Apr. 3, 2000, and entitled “Swimming Gig-Head.”

### BACKGROUND OF THE INVENTION

The present invention relates generally to fishing jigs and related lures. More specifically, the present invention discloses an articulated fishing lure which combines the features of a weighted head, with extending and bendable lip, along with a rearwardly extending hook portion which is typically mounted in articulated fashion relative to the weighted body. The jig lure according to the present invention provides lively, side-to-side motion of the hook and any bait secured to the hook and which more closely replicates live or injured bait. A wide assortment of existing lures may be secured to the jig lure according to the present invention and to further modify its performance characteristics.

### DESCRIPTION OF THE PRIOR ART

Referring to FIG. 8, an example of a standard jig-head is illustrated at 2 and which includes a weight 4 with a hook 6 extending from the weight. An eyelet 8 is also included and to which is secured a fishing line. The sole purpose of the standard jig-head is to add weight to bait to limit or prevent movement of lure attached to the hook and, when trolled through the water, only moves in a straight down direction and does not create any added action or motion to the bait or lure as it descends or is retrieved.

It has long been known that the appearance of injured or dying fish is of particular appeal to underwater predators. Accordingly, a shortcoming of prior art jigs is the failure to provide lively, side-to-side motion of the hook and any bait secured to the hook and which more closely replicates the live or injured bait.

U.S. Pat. No. 4,231,179, issued to Hillesland, discloses a combination tail-wiggling artificial bait and stabilizer plug for imparting a non-spin and non-surface skimming ability to the lure. The plug includes a hollow tubular body formed with a beveled leading end connected at an apex thereof to the fishing line and to a fish hook at a point on the trailing end of the body located in a straight line to the apex extending parallel to the longitudinal axis of the body. The fish hook is baited with the artificial worm having a flat crescent-shaped tail to which the wiggling motion is imparted when pulled through the water.

Finally, U.S. Pat. No. 5,822,914, issued to Tadych, teaches a jig-type fishing lure which simulates the movement of live bait and functions as a weedless fishing lure. The lure includes a typical jig head with a molded head, hook member, and an attachment eye. A pair of spring arms are attached to the molded head such that the spring arms extend upwardly and outwardly from the molded head and intersect one another. The spring arms contact the bottom of a lake or river to simulate the movement of live bait. Upon contacting a weed, the pair of spring arms deflect to prevent the weed from becoming entangled in the barb of the hook member.

### SUMMARY OF THE PRESENT INVENTION

The present invention discloses an improved jig design which causes any hook or lure that is attached behind it to appear more lively during trolling action through the water, such as through eccentric side-to-side and/or circular motion.

It has long been known that the appearance of injured or dying fish is of particular appeal to underwater predators. Accordingly, the jig lure according to the present invention provides lively, side-to-side motion of any bait secured to the hook and which more closely replicates smaller live or injured fish. A softer and articulated connection defined between the jig and rearwardly extending hook portions further provides for a more life-like feel and appearance to the fish striking the bait and upon the attacking fish biting down on the jig and lure. A wide assortment of existing lures may be secured to the hook portion of the jig lure and to further modify its performance characteristics.

The swimming jig includes a weighted head, typically constructed of lead, and having a specified three dimensional rounded shape. An arcuate lip is secured to and extends in a substantially forward direction from the weighted head. In a first preferred embodiment, the arcuate lip is defined in an elongated and bendable configuration and which further modifies the performance characteristics of the swimming jig. In a second embodiment, the arcuate lip includes a substantially forward facing and concave shaped portion and by which the impacting water flow drives the lure upwardly when reeled or trolled through the water.

In either embodiment, an eyelet extends from a further location of the weighted head and is engaged by a fishing line to draw the lure through the water. A hook extends from a substantially rearward direction of the weighted head and to which a conventional type of bait, such as any type of artificial bait, may be affixed. The hook may either be fixed in place being the weighted head or, alternatively, secured in articulated fashion and by interengaging looped or ring-shaped portions. Securing the hook in articulating fashion relative to the weighted body and lip provides the additional aspect of a more life-like appearance to the bait portion, when drawn through the water, and will create a more pliant and life-like feel to the predator fish when biting down on the lure.

It is further contemplated that the swimming jig may be provided with a stem extending internally within the weighted body and interconnecting the eyelet and hook portions. The arcuate lip may be configured with an aperture defined at an interior/embedded end and through which extends the stem for providing additional strength to the device. Alternatively, the jig may be cast as an integral and single piece construction with sufficient strength at the point of connections of the eyelet, arcuate lip and hook.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective view of the swimming jig according to a first preferred embodiment of the present invention;

FIG. 2 is a side cutaway of the swimming jig as shown in FIG. 1 and further illustrating the interconnected nature of the weighted head, lip, eyelet and extending hook according to the preferred embodiment;

FIG. 3 is a further cross sectional cutaway taken along line 3-3 of FIG. 2 and illustrating, in a rearward to forward viewing manner, the rear side profile of the weighted head and arcuate lip according to the first preferred embodiment;

FIG. 4 is a modified variant of the swimming jig according to the first preferred embodiment and illustrating one type of artificial lure secured to the rearward extending hook;

FIG. 5 is a perspective view of the swimming jig according to a second preferred embodiment and illustrating the hook in articulated and interengaging connection with the stem portion extending rearwardly from the weighted head;

FIG. 6 is a side cutaway of a swimming jig as substantially illustrated in FIG. 5 and again showing the interconnected nature of the weighted head, lip, eyelet and extending hook according to the preferred embodiment;

FIG. 7 is a further perspective view of a swimming jig according to a third preferred embodiment and illustrating an alternatively configured lip with a substantially forward facing and concave shaped portion;

FIG. 8 is an illustration of a standard jig-head as known by the prior art.

### DETAILED DESCRIPTION OF THE PREFERRED EMBODIMENTS

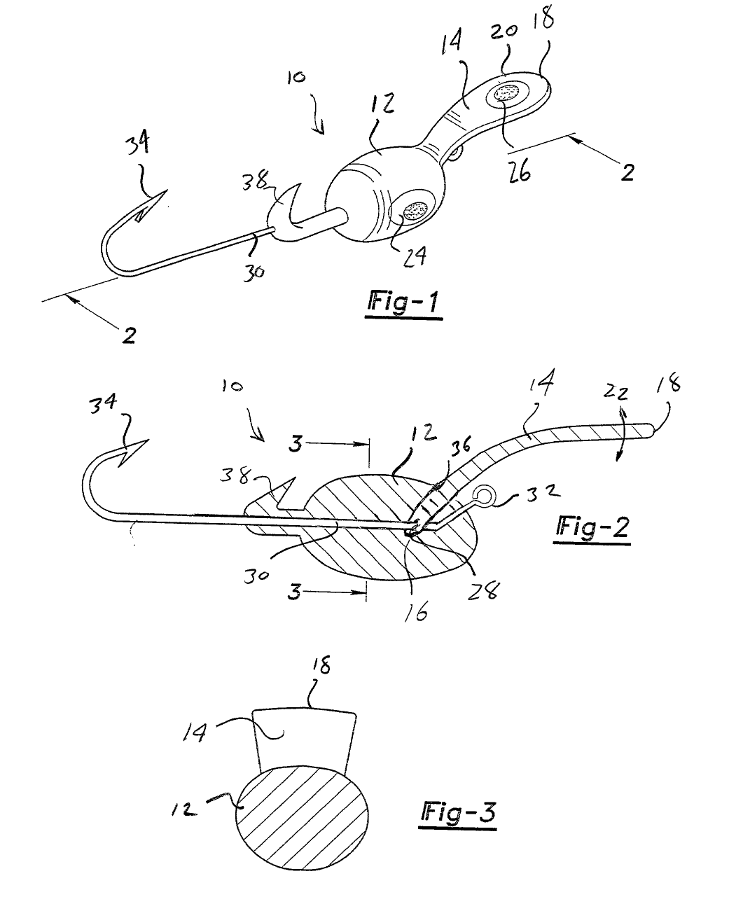

Referring now to FIG. 1, a swimming jig is illustrated at 10 according to a first preferred embodiment of the present invention. As previously explained, the jig lure according to the present invention provides lively, side-to-side motion of the hook and any bait secured to the hook which more closely replicates live or injured bait. The swimming jig therefore more closely approximates the underwater action of an injured fish and, upon striking by a predator fish, more realistically imitates the texture and pliancy associated with live bait fish.

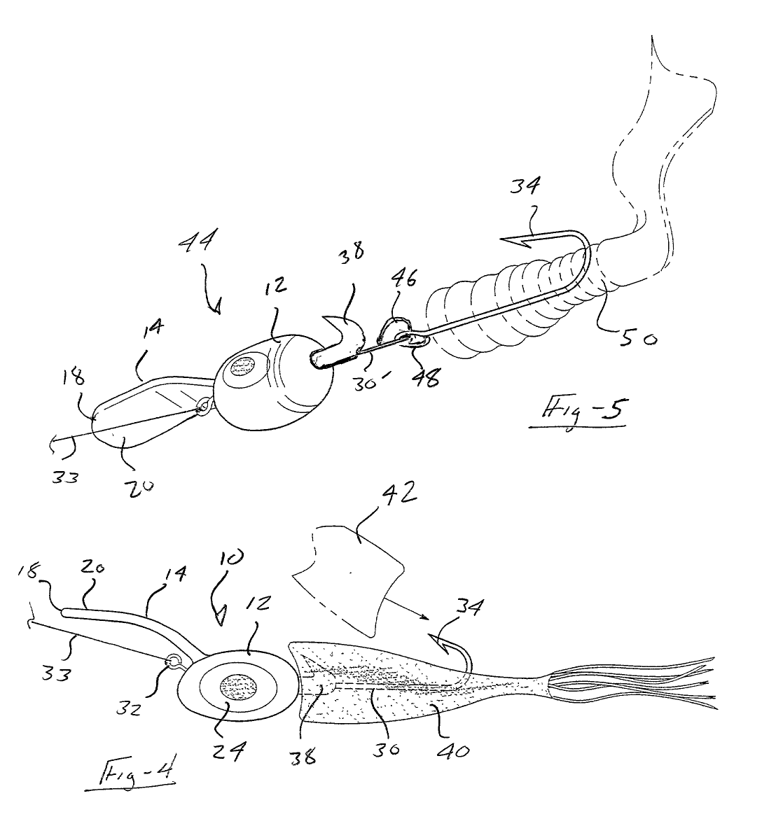

Referring again to FIG. 1, as well as to FIG. 2, the swimming jig 10 includes a weighted head 12, typically constructed of a pliable lead material and having a specified rounded and three dimensional shape. An arcuate lip 14, having a first end 16 and a second end 18, is secured to and extends in a substantially forward direction from the weighted head 12. As is again shown in the perspective view of FIG. 1 (as well as the rearward to forward looking cutaway view of FIG. 3) the lip 14 further includes a generally widened portion 20 (such as contributing to providing an overall “triangular” shape to the lip) and which is located proximate the remote extending and second end 18. The lip 14 is substantially bendable in directions, indicated by arrow 22 in FIG. 2, the net effect of which is to further modify the swim rate, up or down and side-to-side motion, of the swimming jig as it travels through the water.

By example, forward bending of the lip causes it to vibrate slower and to ascend faster through the water, as if feeding off the surface or in an escape mode. Backward bending of the lip causes the jig to swim more slowly, such as imitating a typical food search motion of a small fish, and rest mode near the bottom of the body of water or around the rocks. The design of the arcuate lip 14 further causes the jig, and attached bait, to swim up and over obstacles such as rocks, logs, branches, stumps and weeds. It is also known to provide indicia, such as at 24 and 26, along the weight 12 and lip 14 and to provide a more lifelike appearance to the swimming jig 10.

Referring again to the side cutaway of FIG. 2, an aperture 28 being formed through a portion of the lip 14, embedded within the weighted head 12 and proximate the inner end 16 of the lip. A stem 30 extends through the aperture 28, within the weighted head 12, and terminates at a first substantially forward and projecting end in an eyelet 32 (for receiving a fishing line 33 as shown in FIG. 4) and at a second substantially rearward and likewise projecting end in a hook 34. The interconnecting construction of the stem 30 (with integrally formed eyelet 32 and hook 34) with the bendable lip 14 provides an enhanced degree of resiliency and reinforcement to the construction of the swimming jig.

Along these lines, it is contemplated that the jig is assembled by forming a small notch (see at 36 in FIG. 2) into the forward end of the weighted head 12, within which is inserted the extending end 16 of the lip 14. The lip 14 is further typically glued into the notch 36, however it is envisioned that other ways may be employed for securing the lip within the weighted head and these may also contemplate the swimming jig being constructed as an integral or one-piece construction. An interconnecting portion 38 may also be provided, extending from a rear side location of the weighted head 12, and providing for reinforcing and mounting support to the extending hook 34.

Referring further to FIG. 4, the swimming jig 10 as substantially disclosed in FIGS. 1-3 is again illustrated with an elongated, artificial and flexible body 40 secured to the hook 34 and for the purpose of imparting an additional element of erratic motion to the jig 10. The present invention contemplates the attachment of non-active, artificial lures such as tubes, worms, minnows, crayfish, leeches and centipedes which do not have built-in swimming action and which are normally jerked or flipped by the fishing rod tip (not shown) during casting and retrieval and in the attempt to make the artificial lure appear lively. The swimming jig 10 according to the present invention succeeds in making the lure appear lifelike during trolling or winding retrieval and further imitative of a live but injured and dying fish most appealing to a predator fish. It is also contemplated that other and additional types of bait (see at 42) such as pieces of meat and other actual edibles could be attached to the hook 34, either in lieu of or in addition to artificial lures 40, for the purpose of further appealing to the predator fish.

Referring now to FIG. 5, a further variant 44 is illustrated of the swimming jig head, substantially similar to that previously described throughout FIGS. 1-4, and with the exception of a looped end 46 extending rearwardly from the weighted head 12. The fish hook 34 in this variant is provided with a corresponding looped end 48 interengaging with the looped end 46 of a stem 30′ extending from the weighted head 12 and so that the fish hook 34 is secured in articulated fashion. In this fashion, and upon attaching a suitable artificial lure 50 (see worm design in FIG. 5) the articulated interconnection, combined with the conventional and attachable lure 50, provides an additional element of further weight reduction and erratic swimming motion to the swimming jig. Additionally, and upon striking of the swimming jig 44 by a predator fish (not shown), the combination of the pliancy of the lure 50 and articulated connection of the hook 34 to the jig provides a more life-like feel to the fish, replicating a real wounded fish, and which will increase the likelihood of a successful catch.

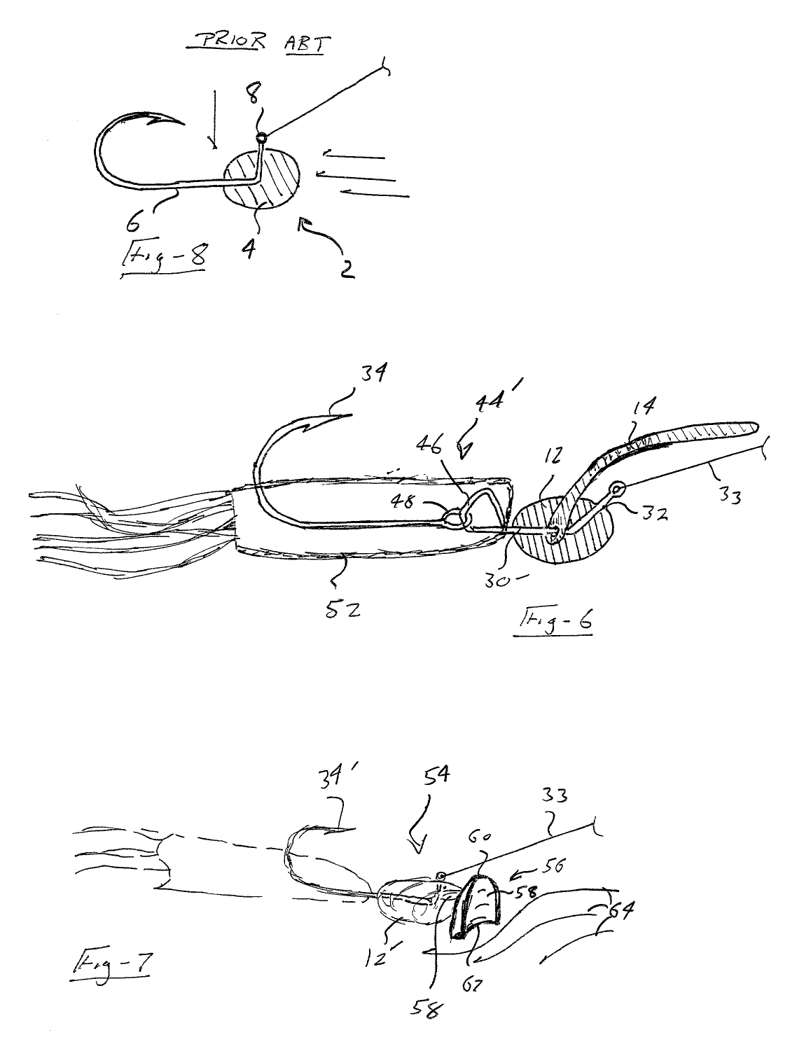

Referring to FIG. 6, a side cutaway is shown of swimming jig 44′, substantially similar to that illustrated in FIG. 5. The jig 44′ again illustrates the interconnected nature of the weighted head 12, arcuate and extending lip 14, eyelet 32 and interconnecting looped ends 46 and 48 for securing in articulated fashion the extending hook 34 according to the preferred embodiment. A further variation 52 of a conventional and artificial lure is shown in the side cutaway illustration of FIG. 6 and further illustrates the ability to mix and match different types of lures/bait to the swimming jig within the scope of the present invention.

Finally, and referring to FIG. 7, an illustration is shown at 54 of a swimming jig according to a further preferred embodiment of the present invention. The swimming jig 54 substantially repeats elements previously described in the prior embodiments, these including the weighted head 12′ and the substantially rearwardly extending hook 34′. In contrast to the elongate lip 14 of the previous embodiments, arcuate lip 56 is secured to and extends in a substantially forward direction from the weighted head 12′, such as through the use of a spacer 58 or other suitable member for mounting the lip 56 in secured fashion relative to the weight 12′. The arcuate lip 56 according to the further preferred embodiment includes a substantially forward facing and concave shaped portion 58 defined within a rounded upper end 60 and a substantially flattened bottom end 62. The effect of the shaping of the concave lip 56 is to cause impacting water currents (see at 64) to push the swimming jig 54 in a substantially upward direction and in combination with the impartation of a unique “wobble” or eccentric motion, again replicating a live but injured or dying fish.

Having described my invention, additional preferred embodiments will become apparent to those skilled in the art to which it pertains and without deviating from the scope of the appended claims:

I claim:

1. A swimming jig for use with a standard attachable bait, the jig head lure providing a measure of erratic and lively behavior to the bait and comprising:
a weighted head;
an arcuate lip secured to and extending in a substantially forward direction from said weighted head;
an eyelet extending from a further location of said weighted head and being engaged by a fishing line; and
a hook extending from a substantially rearward direction of said weighted head and to which the bait is secured.

2. The swimming jig as described in claim 1, said lip further comprising an elongated and arcuate configuration and being bendable in selected forward and rearward directions to affect a swim rate of the jig in both up and down and lateral directions.

3. The swimming jig as described in claim 1, said arcuate lip further comprising a substantially forward facing and concave shaped portion.

4. The swimming jig as described in claim 2, further comprising a stem extending within said weighted portion and interconnecting said hook with said eyelet.

5. The swimming jig as described in claim 4, said elongate and arcuate extending lip further comprising an outer end and an inner end, an aperture being formed through a portion of said lip, embedded within said weighted head and proximate said inner end, said stem extending through said aperture.

6. The swimming jig as described in claim 4, said stem further comprising a looped end extending rearwardly from said weighted head, said fish hook having a corresponding looped end interengaging said looped end of said stem and so that said fish hook is secured in articulated fashion.

7. A swimming jig, comprising:
a weighted head having a specified three dimensional shape;
an arcuate lip secured to and extending in a substantially forward direction from said weighted head, said arcuate lip including an elongated and bendable configuration;
an eyelet extending from a further location of said weighted head and being engaged by a fishing line;
a hook extending from a substantially rearward direction of said weighted head and to which a bait portion is secured, a stem extending within said weighted portion, from said eyelet, and including a looped rear end which interconnects a likewise looped end of said hook so that said hook is secured in articulated fashion; and
said bait portion including an elongated, artificial and flexible body which imparts an extra element of erratic motion upon attachment to said hook.

8. A swimming jig, comprising:
a weighted head having a specified three dimensional shape;
an arcuate lip secured to and extending in a substantially forward direction from said weighted head, said arcuate lip including a substantially forward facing and concave shaped portion;
an eyelet extending from a further and substantially top location of said weighted head and being engaged by a fishing line;
a hook extending from a substantially rearward direction of said weighted head and to which a bait portion is secured, a stem extending within said weighted portion, from said eyelet to said hook; and
said bait portion including an elongated, artificial and flexible body which imparts an extra element of erratic motion upon attachment to said hook.
